(19) United States
(12) Patent Application Publication
(10) Pub. No.: US 2025/0042595 A1
(43) Pub. Date: Feb. 6, 2025

(54) LIQUID STORAGE BOTTLE

(71) Applicant: CANON KABUSHIKI KAISHA, Tokyo (JP)

(72) Inventors: SHIMPEI OTAKA, Kanagawa (JP); HIROKI HAYASHI, Kanagawa (JP)

(21) Appl. No.: 18/778,960

(22) Filed: Jul. 20, 2024

(30) Foreign Application Priority Data
Aug. 4, 2023 (JP) 2023-127496
Apr. 24, 2024 (JP) 2024-070382

(51) Int. Cl. B65D 1/02; B41J 2/175; B65D 1/40; B65D 47/12; B65D 65/38

(52) U.S. Cl. CPC B65D 1/0207; B41J 2/17509; B65D 1/0276; B65D 1/40; B65D 47/12; B65D 65/38; B65D 2565/384

(57) ABSTRACT

A liquid storage bottle includes: a bottle main body that stores a liquid; a nozzle from which the liquid stored in the bottle main body is ejected; and a cap that seals the nozzle, in which, in a first curving portion between a bottom surface and a side surface of the bottle main body in a cross-section of the bottle main body in a vertical direction, a curvature radius of an inner wall is greater than a curvature radius of an outer wall.

### BACKGROUND OF THE INVENTION

### Field of the Invention

The present disclosure relates to a liquid storage bottle used in a liquid ejection apparatus.

### Description of the Related Art

In general, a liquid storage bottle including a storage portion to store a liquid and an outlet for pouring the liquid is used as a liquid storage bottle that is used to refill a liquid ejection apparatus with a liquid. Preferably, such a liquid storage bottle is reused so as to achieve sustainable society such as a decarbonized society/circular society and to respond the current environmental regulations. The liquid storage bottle includes, for example, a bottle as described in Japanese Patent Laid-Open No. 2022-166947 (referred to as Literature 1).

However, in a case of reusing the liquid storage bottle in Literature 1, in cleaning, it is difficult to clean the inside of the bottle because a curvature radius of a bending portion in an outer peripheral portion of a bottom portion is small, and there is a possibility that stain remains. Additionally, if the curvature radius of the bending portion in the outer peripheral portion of the bottom portion is increased, it is difficult for the liquid storage bottle to stand stably, and there is a possibility that the liquid storage bottle tips over easily.

### SUMMARY OF THE INVENTION

A liquid storage bottle according to an aspect of the present disclosure includes: a bottle main body that stores a liquid; a nozzle from which the liquid stored in the bottle main body is ejected; and a cap that seals the nozzle, in which, in a first curving portion between a bottom surface and a side surface of the bottle main body in a cross-section of the bottle main body in a vertical direction, a curvature radius of an inner wall is greater than a curvature radius of an outer wall.

Further features of the present invention will become apparent from the following description of exemplary embodiments with reference to the attached drawings.

### BRIEF DESCRIPTION OF THE DRAWINGS

FIG. 1 is a perspective view of a liquid ejection apparatus;

FIG. 2 is a perspective view illustrating an internal configuration of a major portion of the liquid ejection apparatus;

FIG. 3 is an exploded perspective view of a liquid tank of the liquid ejection apparatus;

FIG. 4 is a schematic cross-sectional view of a liquid storage bottle;

FIGS. 5A and 5B are schematic cross-sectional views of the liquid storage bottle according to a first embodiment;

FIG. 6 is a schematic cross-sectional view of the liquid storage bottle according to a second embodiment;

FIGS. 7A and 7B are diagrams illustrating a detailed example of parts of the liquid storage bottle;

FIGS. 8A to 8C are diagrams describing a sealing portion;

FIGS. 9A and 9B are diagrams describing a nozzle of a slit valve type;

FIG. 10 is an enlarged cross-sectional view of the nozzle and a cap;

FIGS. 11A to 11D are diagrams illustrating a relationship between a slit valve and a protrusion; and

FIGS. 12A and 12B are diagrams describing the nozzle having a two-hole configuration.

### DESCRIPTION OF THE EMBODIMENTS

Embodiments of the present disclosure are described below with reference to the drawings. Note that, the same configurations are described with the same reference numerals. Additionally, relative arrangement, shape, and the like of constituents described in the embodiments are examples.

### First Embodiment

### (Liquid Ejection Apparatus)

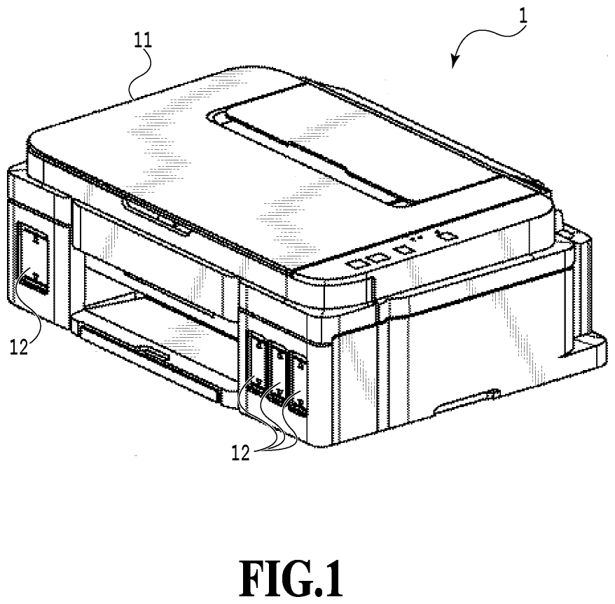

FIG. 1 is a perspective view of a liquid ejection apparatus 1 in which a liquid storage container in the present embodiment is used. The liquid ejection apparatus 1 is a serial type ink jet printing apparatus and includes a housing 11 and a liquid tank 12 arranged inside the housing 11. The liquid tank 12 stores an ink, which is a liquid to be ejected onto a printing medium (not illustrated).

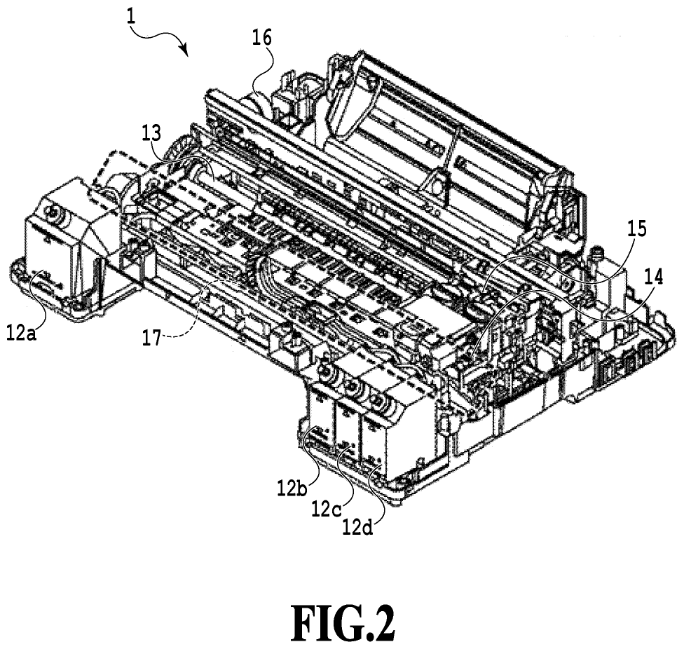

FIG. 2 is a perspective view illustrating an internal configuration of the liquid ejection apparatus 1 illustrated in FIG. 1. The liquid ejection apparatus 1 includes a conveyance roller 13 to convey the printing medium (not illustrated), a liquid ejection head 14 that ejects the liquid, a carriage 15 on which the liquid ejection head 14 is mounted, and a carriage motor 16 to drive the carriage 15. The liquid ejection apparatus 1 includes a liquid passage 17 arranged between the liquid tank 12 and the liquid ejection head 14. A type of the printing medium is not particularly limited as long as an image is formed thereon by the liquid ejected from the liquid ejection head 14. The type of the printing medium may be, for example, paper, cloth, an optical disc label surface, a plastic sheet, an OHP sheet, or the like.

The liquid is stored in the liquid tank 12, supplied to the liquid ejection head 14 via the liquid passage 17, and ejected from the liquid ejection head 14. As the liquid of the present embodiment, for example, four colors of inks (for example, cyan, magenta, yellow, and black) are used. Additionally, four liquid tanks 12a to 12d that store the corresponding colors of inks, respectively, are provided to the liquid tank 12.

Hereinafter, in a case of identifying and mentioning the individual liquid tanks, an alphabet is provided at the end like the liquid tanks 12a to 12d, and in a case of mentioning an arbitrary liquid tank, it is referred to as the liquid tank 12. Each of the four liquid tanks 12a to 12d is arranged in a front surface portion of the liquid ejection apparatus 1 inside the housing 11.

### (Liquid Tank)

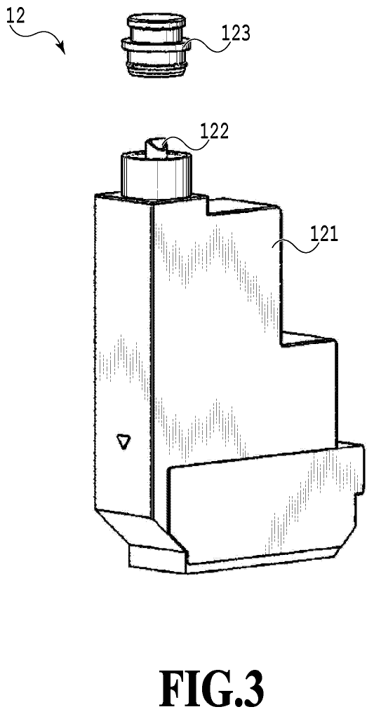

FIG. 3 is an exploded perspective view of the liquid tank 12 of the liquid ejection apparatus 1 illustrated in FIG. 1. The liquid tank 12 of the present embodiment includes a liquid tank main body 121 to store the liquid, an inlet 122 communicating with a liquid storage chamber in the liquid tank main body 121, and a tank lid 123 that can be mounted on the liquid tank main body 121 so as to cover the inlet 122. After the liquid tank 12 is refilled with the liquid, in order to suppress evaporation of the liquid from the liquid storage chamber in the liquid tank main body 121, the tank lid 123 is attached to the liquid tank main body 121 to seal the liquid storage chamber in the liquid tank main body 121.

### (Liquid Storage Bottle)

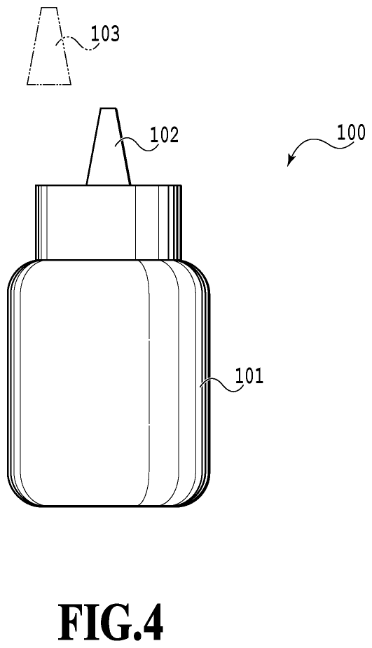

In the present embodiment, a liquid storage bottle to refill the above-described liquid ejection apparatus with the ink is an application of a liquid storage bottle of the present disclosure. FIG. 4 is a schematic cross-sectional view illustrating the liquid storage bottle according to the present embodiment. A liquid storage bottle 100 includes a bottle main body 101 storing the liquid, a nozzle 102 ejecting the liquid stored in the bottle main body 101, and a cap 103 sealing the nozzle 102.

In general, resin or metal that does not harm the liquid to be stored is used as material of the liquid storage bottle 100. In detail, a common resin material, fluorine resin, or the like may be used as the material of the liquid storage bottle. As the common resin material, virgin material and recycled plastic material are both used by blow molding. For example, any one of polypropylene (PP), polyethylene (PE), polyethylene terephthalate (PET), polyvinyl chloride (PVC), and polystyrene (PS) can be used. However, it is not limited thereto, and another resin material may be used, or multiple materials may be used. That is, as the recycled plastic material, one type out of PP, PE, PET, PVC, and PS or a mixture of multiple types can be used. Use of fluorine resin can provide better chemical resistance and weather resistance and higher strength than common resin. Note that, common resin may be coated with fluorine resin. This makes it possible to obtain a similar effect as that of a case of using fluorine resin.

If it is desired to increase a mechanical strength, metal material may be used as the material of the liquid storage bottle. In addition, as the material of the liquid storage bottle, a material that is insoluble in the liquid stored in the bottle and has resistance to an impact and temperature change during distribution may be used as the material of the bottle main body 101. In addition, in the present embodiment, recycled plastic material may be used, and a material including a post-consumer material (a PCR material) and a pre-consumer material may be used. Here, as a usage ratio of recycled plastic material, 5 wt % or more of the total is used.

The post-consumer material (the PCR material) is a material that is obtained by collecting and reusing plastic products after distributed to the market. For example, the PCR material is plastic prepared from cleaned and crushed wastes. The PCR material may be thermoplastic plastic prepared from industrial waste plastic by someone other than the first processor. The pre-consumer material is a material that is obtained by collecting and reusing waste plastic generated in a manufacturing process before distribution to the market. For example, the pre-consumer material is thermoplastic plastic prepared from a molded product that is cut off or rejected after being processed in advance by molding or extrusion in a factory of a processor, and then reworked by the same factory. In the present embodiment, the recycled plastic material may be either the PCR material or the pre-consumer material. Additionally, the recycled plastic material may be a mixed material of the materials.

In a case of reusing the liquid storage bottle 100 after the liquid storage bottle 100 finishes ejecting the liquid, the inside of the liquid storage bottle 100 is cleaned. In a case of cleaning the liquid storage bottle 100, it is desirable to clean it as easily as possible. This is because, if cleaning is laborious, the cleaning cost is increased, and the cost of reusing rises accordingly. Additionally, as the center of gravity of the liquid storage bottle 100 is higher, there is a possibility that the liquid storage bottle 100 tips over more easily. A shape that suppresses the tip-over while improving the cleaning efficiency of the liquid storage bottle 100 is described.

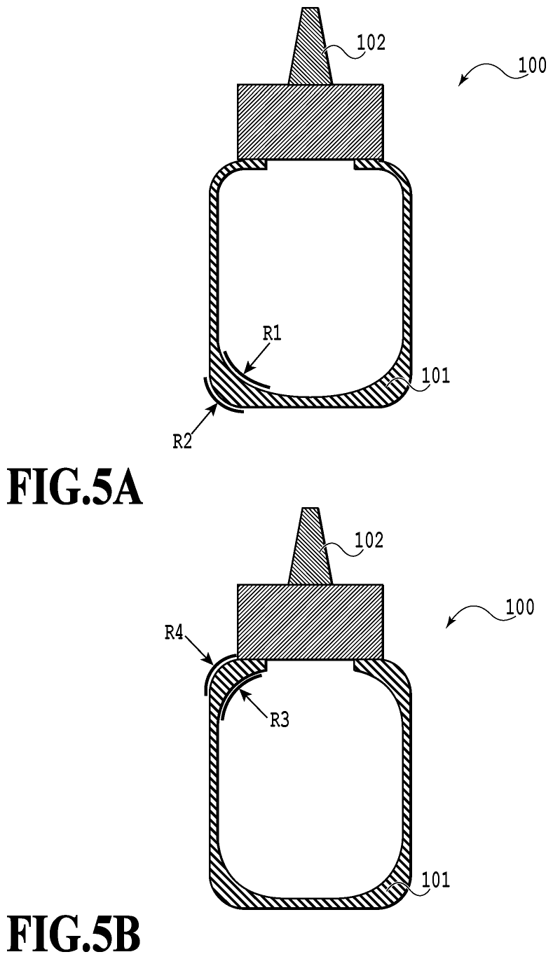

FIG. 5A is a schematic cross-sectional view of the liquid storage bottle 100 according to a first embodiment of the present disclosure. The liquid storage bottle 100 includes the bottle main body 101, the nozzle 102 that allows the liquid in the bottle main body 101 to flow out, and the cap 103 that is positioned on top of the bottle main body 101 and seals the nozzle 102. In the present embodiment, a shape of a bottom surface of the bottle main body 101 is formed in a circular shape. Although it is assumed that the shape of the bottom surface of the bottle main body 101 is formed in a circular shape, it is not limited thereto, and the bottom surface of the bottle main body 101 may be formed in a polygonal shape. After the liquid is stored, the liquid storage bottle 100 is closed with the cap 103 and sealed so as not to spill the liquid. A hole opens at a tip of the nozzle 102, and this hole is sealed by the cap 103.

In the present embodiment, a first curving portion is included between a bottom surface and a side surface of the liquid storage bottle 100. In FIG. 5A, the first curving portion of the liquid storage bottle 100 in a cross-section of the liquid storage bottle 100 in a vertical direction has different curvature radii between an inner wall and an outer wall. In the present embodiment, a curvature radius R1 of the inner wall of the first curving portion is greater than a curvature radius R2 of the outer wall. For example, in one embodiment, the curvature radius R1 of the inner wall of the liquid storage bottle 100 is 50 mm while the curvature radius R2 of the outer wall is 20 mm. The curvature radius R1 of the inner wall of the liquid storage bottle 100 may be within a range of 1.0 mm or greater and 50 mm or smaller. Additionally, the curvature radius R2 of the outer wall of the liquid storage bottle 100 may be within a range of 0.5 mm or greater and 50 mm or smaller under a relationship that the curvature radius R1 of the inner wall of the first curving portion is greater than the curvature radius R2 of the outer wall. The curvature radius R1 of the inner wall and the curvature radius R2 of the outer wall of the liquid storage bottle 100 are preferably within a range of 2.0 mm or greater and 25 mm or smaller under the relationship that the curvature radius R1 of the inner wall of the first curving portion is greater than the curvature radius R2 of the outer wall. In addition, the curvature radius R1 of the inner wall and the curvature radius R2 of the outer wall of the liquid storage bottle 100 are preferably within a range of 3.0 mm or greater and 15 mm or smaller under the relationship that the curvature radius R1 of the inner wall of the first curving portion is greater than the curvature radius R2 of the outer wall.

Thus, in the first curving portion between the bottom surface and the side surface of the liquid storage bottle, if the curvature radius R1 of the inner wall is small, circularity of the cleaning liquid inside the liquid storage bottle 100 during cleaning is low. However, with the great curvature radius R1 in the first curving portion between the bottom surface and the side surface of the liquid storage bottle, it is possible to improve the circularity of the cleaning liquid inside the liquid storage bottle 100. Therefore, it is possible to improve the washability of the liquid storage bottle.

On the other hand, if the curvature radius R1 of the inner wall is formed excessively great in the first curving portion positioned between the bottom surface and the side surface of the liquid storage bottle 100, there is a possibility that the bottle main body 101 tips over. Additionally, as a bottom area of the liquid storage bottle 100 is smaller, there is a possibility that the liquid storage bottle 100 tips over more easily. To deal with this, in the present embodiment, the curvature radius R2 of the outer wall is formed small in the first curving portion between the bottom surface and the side surface of the liquid storage bottle 100 to improve the stable standing of the bottle main body 101. In a case of the present embodiment, the curvature radius R2 of the outer wall is 20 mm. Thus, in the first curving portion of the liquid storage bottle 100, the curvature radius of the inner wall is formed greater than the curvature radius of the outer wall, and thus it is possible to achieve both the washability of the inside of the liquid storage bottle 100 and the stable standing thereof. In addition, it is possible to increase a thickness of the first curving portion by reducing the curvature radius R2 of the outer wall of the first curving portion. With the great thickness of the first curving portion, it is possible to improve strength of the liquid storage bottle 100.

Additionally, FIG. 5B is a schematic cross-sectional view in a case where a second curving portion is provided between a top surface and the side surface of the liquid storage bottle 100 according to the first embodiment of the present disclosure. In the present embodiment, an opening portion is provided in the top surface of the liquid storage bottle 100, and the nozzle 102 is provided such that the nozzle 102 and the inside of the liquid storage bottle 100 communicate with each other via the opening portion. In FIG. 5B, the second curving portion between the top surface and the side surface of the liquid storage bottle 100 in a cross-section of the liquid storage bottle 100 in the vertical direction has different curvature radii between the inner wall and the outer wall. In the present embodiment, a curvature radius R3 of the inner wall of the second curving portion is greater than a curvature radius R4 of the outer wall. The curvature radius R3 of the inner wall of the second curving portion of the liquid storage bottle 100 in the present embodiment is 50 mm while the curvature radius R4 of the outer wall is 20 mm. The curvature radius R3 of the inner wall of the second curving portion of the liquid storage bottle 100 may be within a range of 1.0 mm or greater and 50 mm or smaller. Additionally, the curvature radius R4 of the outer wall of the liquid storage bottle 100 may be within a range of 0.5 mm or greater and 50 mm or smaller under the relationship that the curvature radius R3 of the inner wall of the second curving portion is greater than the curvature radius R4 of the outer wall. The curvature radius R3 of the inner wall and the curvature radius R4 of the outer wall of the second curving portion of the liquid storage bottle 100 are preferably within a range of 2.0 mm or greater and 25 mm or smaller under the relationship that the curvature radius R3 of the inner wall of the second curving portion is greater than the curvature radius R4 of the outer wall. In addition, the curvature radius R3 of the inner wall and the curvature radius R4 of the outer wall of the second curving portion of the liquid storage bottle 100 are preferably within a range of 3.0 mm or greater and 15 mm or smaller under the relationship that the curvature radius R3 of the inner wall of the second curving portion is greater than the curvature radius R4 of the outer wall.

Thus, with the great curvature radius R3 of the inner wall of the second curving portion of the liquid storage bottle 100, it is possible to improve the circularity of the cleaning liquid inside the liquid storage bottle 100, and it is possible to further improve the washability of the liquid storage bottle 100. In other words, it is possible to facilitate reusing of the liquid storage bottle 100, and it is also possible to respond the environmental regulations. That is, the technologies described in this specification have the potential to contribute to the achievement of a sustainable society, such as a decarbonized society/circular society. Additionally, the curvature radius R3 of the inner wall of the second curving portion of the liquid storage bottle 100 is greater than the curvature radius R4 of the outer wall. The second curving portion of the liquid storage bottle does not affect the stable standing of the liquid storage bottle 100; however, it is possible to increase a thickness of the second curving portion by reducing the curvature radius R4 of the outer wall. With the great thickness of the second curving portion, it is possible to improve the strength of the liquid storage bottle 100. In addition, it is possible to improve resistance of the liquid storage bottle to an impact and the like during distribution.

### Second Embodiment

A second embodiment of the present disclosure is described. Descriptions of a basic configuration of the present disclosure and a function and a configuration similar to that of the first embodiment are omitted, and different points are described.

In the present embodiment, in the bottom surface of the liquid storage bottle, the curvature radii are different between the outer wall and the inner wall of the first curving portion as with the first embodiment, and the washability and the stable standing of the liquid storage bottle are both achieved.

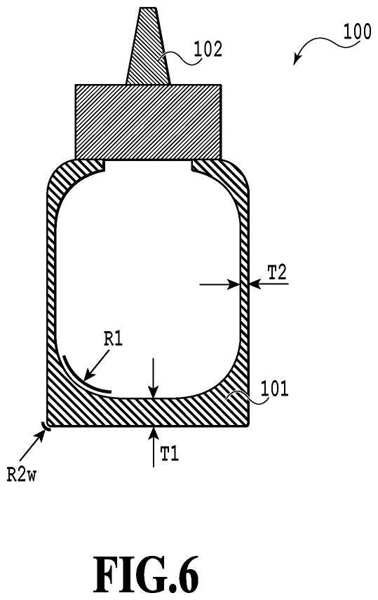

FIG. 6 is a schematic cross-sectional view illustrating the liquid storage bottle according to the second embodiment. In FIG. 6, a thickness of the bottom surface of the liquid storage bottle 100 and a thickness of the side surface of the liquid storage bottle 100 are different from each other. In the present embodiment, the thickness of the bottom surface of the liquid storage bottle 100 is thicker than the thickness of the side surface of the liquid storage bottle 100. In the present embodiment, a thickness T1 of the bottom surface of the liquid storage bottle 100 has a greater thickness than a thickness T2 of the side surface of the liquid storage bottle 100. The thickness T1 of the bottom surface of the liquid storage bottle 100 of the present embodiment may be within a range of 0.5 mm or greater and 5.0 mm or smaller. The thickness T1 of the bottom surface of the liquid storage bottle 100 is preferably within a range of 0.3 mm or greater and 3.0 mm or smaller.

On the other hand, as for the side surface of the liquid storage bottle 100 of the present embodiment, since the side surface is squeezed by hand to eject the liquid inside, the side surface needs to have flexibility for easy squeezing. Therefore, the thickness of the side surface is accordingly thin. The thickness T2 of the side surface of the liquid storage bottle 100 may be within a range of 0.1 mm or greater and 5.0 mm or smaller under the relationship that the thickness of the bottom surface is thicker than the thickness of the side surface. The thickness T2 of the side surface of the liquid storage bottle 100 is preferably within a range of 0.2 mm or greater and 3.0 mm or smaller under the relationship that the thickness of the bottom surface is thicker than the thickness of the side surface. In addition, the thickness T1 of the bottom surface and the thickness T2 of the side surface of the liquid storage bottle 100 are preferably within a range of 1.0 mm or greater and 2.0 mm or smaller under the relationship that the thickness of the bottom surface is thicker than the thickness of the side surface.

Thus, it is possible to improve the stable standing of the liquid storage bottle 100 by forming the bottom surface of the liquid storage bottle 100 thick. Additionally, it is possible to facilitate the squeezing by forming the side surface of the liquid storage bottle 100 thin. In addition, in the liquid storage bottle 100, it is possible to improve resistance to an impact and the like during distribution while improving the strength of the liquid storage bottle itself.

### Other Embodiments

### (Configuration of Liquid Supply Unit (Nozzle))

In the first embodiment and the second embodiment, the curvature radii and the thicknesses of the first curving portion and the second curving portion of the bottle main body 101 are mainly described. A configuration example of a nozzle 22, which is a liquid supply unit in the liquid storage bottle 100, is described below.

### (Valve Spring Configuration)

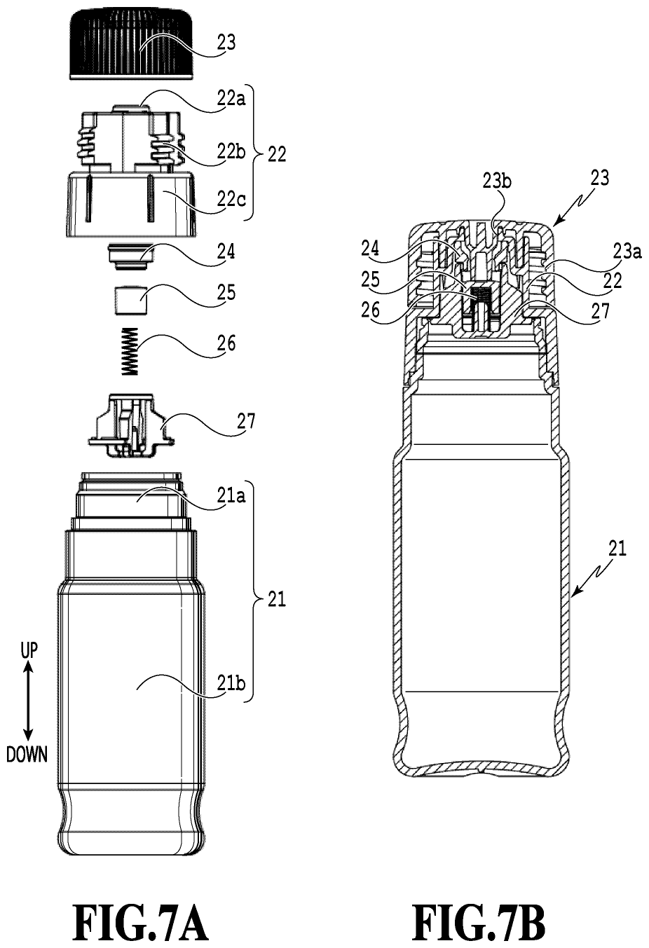

FIGS. 7A and 7B are diagrams illustrating a further detailed example of parts of the liquid storage bottle 100. FIG. 7A is a diagram illustrating an example of a part configuration diagram of the liquid storage bottle 100 illustrated in FIG. 4. FIG. 7B is a cross-sectional view of a coupled state of the part configuration diagram of the liquid storage bottle 100 illustrated in FIG. 7A. Inside of the nozzle 22, a sealing 24 that includes an opening, a valve 25 that opens and closes the opening of the sealing 24, a spring 26 that biases the valve 25, and a holder 27 that fixes the spring 26 are included.

In a case of supplying the liquid from the liquid storage bottle 100 to the liquid tank 12, the inlet 122 of the liquid tank 12 is inserted into the opening of the nozzle 22 of the liquid storage bottle 100. In the nozzle 22 of the liquid storage bottle 100, a concave portion to be engaged with a projection portion provided to the liquid ejection apparatus 1 is provided, and the liquid storage bottle 100 is positioned while inserting the inlet 122 into the opening of the nozzle 22. Then, the liquid in the liquid storage bottle 100 is supplied to a storage chamber of the liquid tank main body 121 via the inlet 122 due to a water head difference.

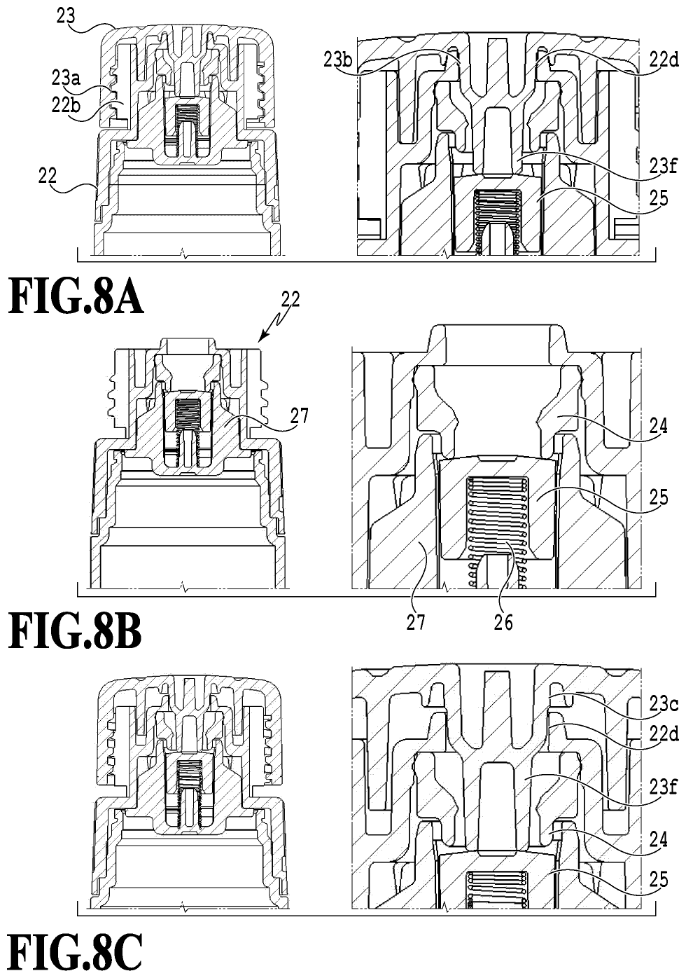

The liquid storage bottle 100 includes two sealable portions (hereinafter, referred to as sealing portions). FIGS. 8A to 8C are diagrams describing the sealing portion. In a first sealing portion, as illustrated in FIG. 8A, sealing is performed by fitting a cap 23 and the nozzle 22 to each other. In a second sealing portion, as illustrated in FIG. 8B, sealing is performed by a valve structure in the nozzle 22. Each sealing portion is described below.

The first sealing portion is described with reference to FIG. 8A. FIG. 8A is a cross-sectional view of an upper portion of the liquid storage bottle 100 in a state in which the cap 23 is mounted on the nozzle 22, and an enlarged view thereof is also illustrated. The first sealing portion is a portion in which a cap sealing portion 23b of the cap 23 and a nozzle sealing portion 22d, which is a part of an outlet 22a of the nozzle 22, are fitted to each other by mounting the cap 23 on the nozzle 22. An example of a method of mounting the cap 23 on the nozzle 22 includes a method of screwing the nozzle 22 and the cap 23 together. Specifically, as illustrated in FIGS. 7A, 7B, and 8A, there is a method of screwing using a nozzle screw portion 22b in which a male screw structure is formed on an outer side of the nozzle 22, and a cap screw portion 23a in which a female screw structure is formed on an inner side of a lower portion of the cap 23. Note that, to the contrary, the cap 23 on which a male screw portion is formed and the nozzle 22 on which a female screw portion is formed may be used.

Additionally, as a method of mounting the cap 23 on the nozzle 22, a portion for fitting without screwing may be provided in addition to the sealing portion. For example, a configuration of an outer fitting lid that allows the cap 23 to fit to the outer side of the nozzle 22 or a configuration of an inner fitting lid that allows the cap 23 to fit to an inner side of the nozzle 22 may be applied.

The second sealing portion is described with reference to FIG. 8B. FIG. 8B is a cross-sectional view of the upper portion of the liquid storage bottle 100 in a state in which the cap 23 is not mounted, and an enlarged view thereof is also illustrated. The second sealing portion is a portion of a liquid stop valve structure (a valve structure) arranged inside the nozzle 22 of the liquid storage bottle 100. As illustrated in FIG. 8B, in the nozzle 22, the sealing 24 that is an orifice portion including the opening at a tip (an upper end) thereof into which the inlet 122 is inserted. Additionally, a gap between the sealing 24 and the valve 25 is closed by biasing the valve 25 that is a valve body of the liquid stop valve by the spring 26 toward the opening, and the liquid storage bottle 100 is sealed. In the present example, the spring 26 is used as a biasing mechanism, and the spring 26 is held by the holder 27 fixed in an internal space of the nozzle 22. The sealing 24 is formed of a flexible member such as rubber or elastomer.

With this liquid stop valve structure, the valve 25 is biased by the spring 26 to the opening of the sealing 24, and thus it is possible to maintain a sealing state of the inside of the liquid storage bottle 100 even in a state in which the cap 23 is removed from the nozzle 22. In a case of supplying the liquid from the liquid storage bottle 100 to the liquid tank 12, the valve 25 is opened by inserting the inlet 122 into the nozzle 22 through the opening of the sealing 24. Then, as mentioned above, the liquid in the liquid storage bottle 100 is supplied to the storage chamber of the liquid tank main body 121 via the inlet 122 due to the water head difference.

In the present example, a configuration that allows those sealing portions in the two portions to concurrently open temporarily in opening the cap 23 from the nozzle 22 and in closing the nozzle with the cap 23 is applied. Thus, it is possible to allow the inside of the liquid storage bottle 100 to communicate with atmosphere and to equalize a pressure inside the liquid storage bottle 100 and the atmospheric pressure. Detailed descriptions are given below.

First, in a closed state of the cap 23, as illustrated in FIG. 8A, it is a state in which the first sealing portion is sealed. On the other hand, in the second sealing portion, a protrusion 23f arranged on the cap 23 is pushed in an opposite direction of the direction of biasing the valve 25 while closing the cap 23; for this reason, the gap is formed between the sealing 24 and the valve 25. Thus, in FIG. 8A, it is an open state in the second sealing portion. That is, in the closed state of the cap 23, the first sealing portion is sealed while the second sealing portion is opened.

FIG. 8C is a cross-sectional view of the upper portion of the liquid storage bottle 100 in a state in which the cap 23 is started to be opened from a state in which the cap 23 is mounted on the nozzle 22 illustrated in FIG. 8A, and an enlarged view thereof is also illustrated. The cap 23 is moved upward while opening as illustrated in FIG. 8C from the closed state illustrated in FIG. 8A. Along with this movement of the cap 23, the cap sealing portion 23b and the nozzle sealing portion 22d are separated from each other, and the first sealing portion is opened. In a case where the first sealing portion is opened, the protrusion 23f arranged on the cap 23 is still in a position to push the valve 25 as illustrated in FIG. 8C. That is, the second sealing portion maintains the open state. Accordingly, as illustrated in FIG. 8C, it is possible to open the second sealing portion concurrently with the opening of the first sealing portion. Thereafter, once the cap 23 is further moved upward, the protrusion 23f is completely moved away from the valve 25 along with the movement of the cap 23, and the second sealing portion is sealed as illustrated in FIG. 8B. Note that, also in a case where the cap 23 is closed from the open state, the valve 25 is pushed by the protrusion 23f of the cap 23 along with the movement of the cap 23, and the second sealing portion is opened. In this process, the first sealing portion is in a state before sealing, and thus the open state is maintained. Thereafter, the first sealing portion transitions to a sealed state by bringing the cap 23 to the closed state. Note that, the concurrent opening of the first sealing portion and the second sealing portion means that it is substantially concurrent opening. In a case where the second sealing portion is opened in conjunction with the opening of the first sealing portion, the two sealing portions are opened concurrently.

With the above-described configuration, since the first sealing portion and the second sealing portion are concurrently in the open state temporarily in a case of opening the cap 23, the inside of the liquid storage bottle 100 communicates with the atmosphere, and it is possible to equalize the pressure inside the liquid storage bottle 100 and the atmospheric pressure. Therefore, in a case of refilling of the liquid tank main body 121 with the liquid from the liquid storage bottle 100 by opening the cap 23, it is possible to suppress squirting of the liquid caused by a rise in the internal pressure of the liquid storage bottle 100. Additionally, it is possible to suppress overflow of the liquid from the liquid tank main body 121. Moreover, since the sealed state of the inside of the liquid storage bottle 100 is maintained by the second sealing portion also in a case where the cap 23 is opened, it is possible to suppress leaking of the liquid even if the liquid storage bottle 100 is upside down.

### (Slit Valve Configuration)

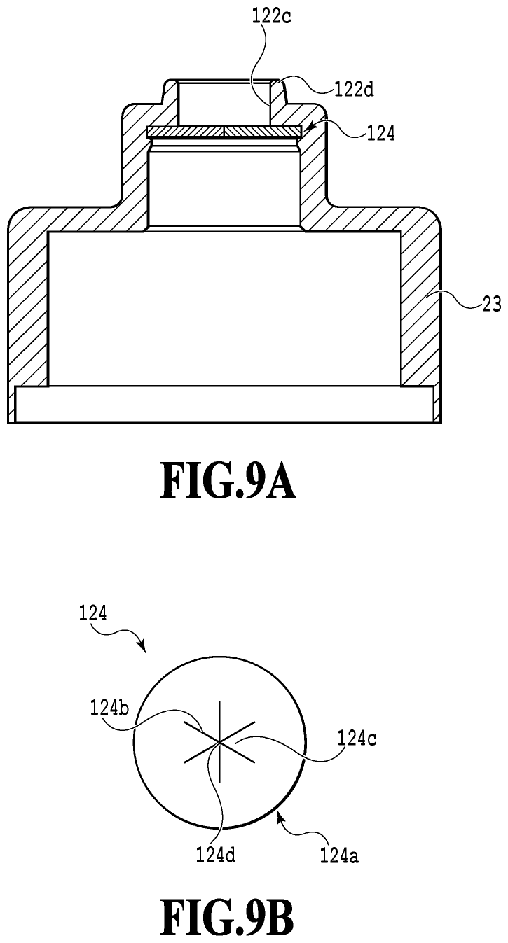

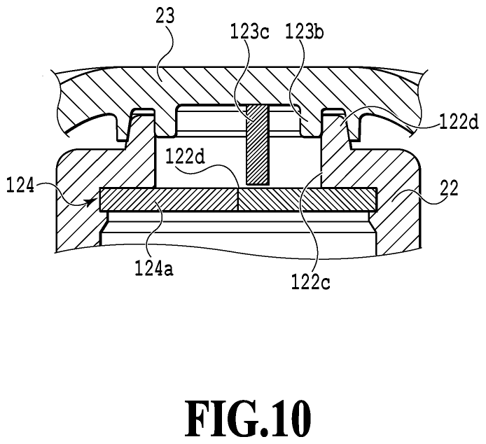

FIGS. 9A and 9B are diagrams describing the nozzle 22 of a slit valve type. FIG. 9A is a cross-sectional view of the nozzle of the present example, and FIG. 9B is a plan view of a slit valve provided to the nozzle of the present example. FIG. 10 is an enlarged cross-sectional view of the nozzle 22 and the cap of the present example.

The nozzle 22 includes a spout 122c to pour the liquid and a nozzle sealing portion 122d formed of a ring-shaped rib provided along a periphery portion of the spout 122c. A slit valve 124 that is opened and closed according to the internal pressure of the liquid storage bottle 100 is provided to the spout 122c. The slit valve 124 includes a valve body 124a formed of a flexible material and three slits 124b that are formed in the valve body 124a and cross with each other, and it is possible to seal the spout 122c in a closed state. In the valve body 124a, six fragments 124c are formed by the three slits 124b. Note that, the number of the slits 124b is not limited thereto and may be two or four or more. In this case, assuming that the number of the multiple slits 124b is n, the multiple slits 124b are preferably formed to be symmetric with respect to the center of the circular valve body 124a 2n times as illustrated in FIG. 9B. Thus, it is possible to open the fragments 124c evenly, and it is possible to smoothly pour the liquid in the liquid storage bottle 100.

A cap sealing portion 123b formed of a ring-shaped rib and a protrusion 123c protruding toward the slit valve 124 are provided to a bottom surface (a surface facing the spout 122c) of the cap 23. The cap sealing portion 123b is fitted to the nozzle sealing portion 122d in a case where the cap 23 is mounted on the nozzle 22 and thus functions as a sealing unit that seals the spout 122c with the nozzle sealing portion 122d. In a state in which the spout 122c is sealed by the cap sealing portion 123b and the nozzle sealing portion 122d, a tip portion of the protrusion 123c faces the valve body 124a of the slit valve 124 in a position away from an intersection point 124d of the multiple slits 124b in a transverse direction. The transverse direction corresponds to a radius direction of the nozzle 22. With such a configuration of the protrusion 123c, as described later, in a case where the internal pressure of the liquid storage bottle 100 is higher than the atmospheric pressure in opening the cap 23, it is possible to release the internal pressure. In the present example, the protrusion 123c is provided integrally with the cap 23; however, the protrusion 123c may be provided separately from the cap 23.

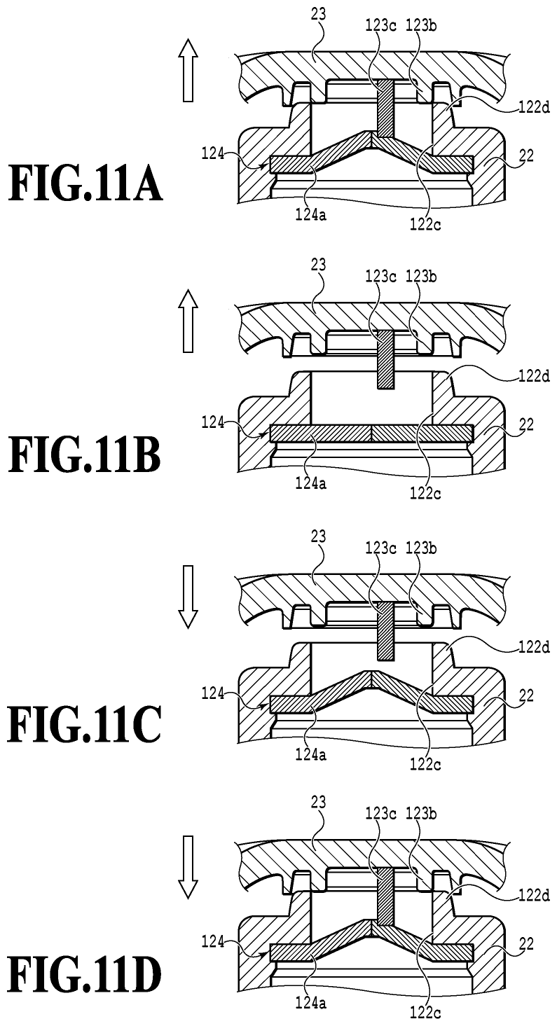

FIGS. 11A to 11D are diagrams illustrating a relationship between the slit valve 124 and the protrusion 123c. FIGS. 11A and 11B are cross-sectional views illustrating a relationship between the slit valve and the protrusion in opening the cap. In a state in which the cap 23 is mounted on the nozzle 22, and the spout 122c is sealed, the protrusion 123c faces the valve body 124a in a position away from the intersection point 124d of the slits 124b in the transverse direction and is not put in contact with the valve body 124a as described above. In this state, once the cap 23 is started to be opened, the fitting between the cap sealing portion 123b and the nozzle sealing portion 122d is released, and the sealing of the spout 122c is released. In this process, in a case where the internal pressure of the liquid storage bottle 100 is higher than the atmospheric pressure, the valve body 124a of the slit valve 124 is bulged and deformed outward due to the internal pressure of the liquid storage bottle 100 as illustrated in FIG. 11A. Then, once the bulged valve body 124a is put in contact with the protrusion 123c, the slits 124b are opened, the pressure inside the liquid storage bottle 100 is released, and the bulge of the valve body 124a is solved. Thereafter, once the cap 23 is removed, the slits 124b are closed, and the spout 122c is sealed again as illustrated in FIG. 11B. In a case of pouring the liquid from the liquid storage bottle 100 into the liquid tank 12, a difference in air pressure between the inside and the outside of the liquid storage bottle 100 is solved, and the spout 122c is in the sealed state. Therefore, in a case where a bottle main body 21 is only tilted, an effect of the pressure required to open the slits 124b on the slit valve 124 is suppressed, and it is possible to suppress leaking of the liquid from the spout 122c.

On the other hand, FIGS. 11C and 11D are cross-sectional views illustrating a relationship between the slit valve and the protrusion in closing the cap. In a case where the internal pressure of the liquid storage bottle 100 rises in a state in which the cap 23 is not mounted on the nozzle 22, the valve body 124a of the slit valve 124 is bulged and deformed outward as illustrated in FIG. 11C. In this state, once the cap 23 is started to be closed, the protrusion 123c is put in contact with the bulged valve body 124a before the cap sealing portion 123b and the nozzle sealing portion 122d are fitted to each other as illustrated in FIG. 11D. Thus, the slits 124b are opened, the pressure inside the liquid storage bottle 100 is released, and the bulge of the valve body 124a is solved. Thereafter, the slits 124b are closed, and the spout 122c is sealed. Then, in a case of continuing to close the cap 23, the cap sealing portion 123b and the nozzle sealing portion 122d are fitted to each other, and the spout 122c is sealed. In this state, since the bulge of the valve body 124a is solved, the protrusion 123c faces the valve body 124a in a position away from the intersection point 124d of the slits 124b in the transverse direction and is not put in contact with the valve body 124a.

With such a configuration, even in a case where the internal pressure of the liquid storage bottle 100 rises, it is possible to release the internal pressure to the outside because the protrusion 123c is put in contact with the slit valve 124 in opening and closing the cap 23. Note that, a length of the protrusion 123c is not particularly limited, and it is possible to set the length to an optimal length according to a deformation amount of the actual deformation of the valve body 124a due to the rise in the internal pressure of the liquid storage bottle 100. For example, in a case where the deformation amount of the valve body 124a is relatively small, the tip portion of the protrusion 123c may be put in contact with the valve body 124a without causing deformation to the valve body 124a in a state in which the spout 122c is sealed by the cap sealing portion 123b and the nozzle sealing portion 122d.

Note that, the configuration as illustrated in FIG. 10 may also be applied in a case of only bringing the protrusion 123c into contact with the bulged valve body 124a. That is, it is also possible to bring the tip portion of the protrusion 123c to face the intersection point 124d of the slits 124b in a state in which the cap 23 is mounted on the nozzle 22 (a state in which the spout 122c is sealed). However, in this case, depending on the thickness of the protrusion 123c, the protrusion 123c is inserted into the slits 124b near the intersection point 124d in a case where the valve body 124a is bulged. Additionally, in some cases, the closed state of the slits 124b may be maintained even if the protrusion 123c is inserted like this. As a result, the pressure inside the liquid storage bottle 100 may not be released even if the protrusion 123c is put in contact with the bulged valve body 124a. In this respect, the tip portion of the protrusion 123c preferably faces the valve body 124a of the slit valve 124 in a position away from the intersection point 124d of the multiple slits 124b in the transverse direction in a state in which the spout 122c is sealed.

### (Two-Hole Configuration)

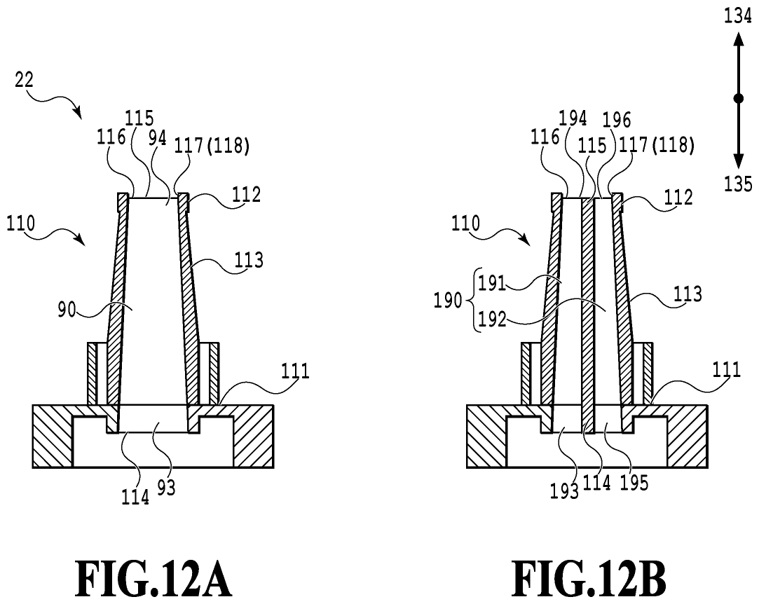

FIGS. 12A and 12B are diagrams describing a nozzle having a two-hole configuration. FIGS. 12A and 12B are cross-sectional views of the nozzle 22. As illustrated in FIG. 12A, a nozzle unit 110 protrudes from an outer surface of a bottom wall 111 of the nozzle 22 in a first direction 134. That is, in a state in which the nozzle 22 is mounted on the bottle main body 21, the nozzle unit 110 protrudes in the first direction 134 from the bottle main body 21 via the nozzle 22. The nozzle unit 110 may protrude from the bottom wall 111 in the first direction 134 and also protrude from the bottom wall 111 in a second direction 135. In this case, the nozzle is provided to penetrate the bottom wall 111.

The nozzle unit 110 has substantially a column shape. The nozzle unit 110 includes an outer peripheral surface 112 having a cross-section in the form of a surface of a perimeter of circle. An outer peripheral surface 113 that is apart of the outer peripheral surface 112 has a tapered shape and is inclined from the bottom wall 111 toward the first direction 134 in a direction in which a diameter of an outer peripheral circle is reduced. With such a shape, the nozzle unit 110 can move smoothly while being inserted into the tank sequentially from a distal end side away from the bottle main body 21. Note that, in the nozzle unit 110, the outer peripheral surface may extend in a perpendicular direction with no change in the diameter of the outer peripheral circle from the bottom wall 111 to the tip. Additionally, the nozzle unit 110 may have a shape other than the column shape and may be, for example, a square column shape.

The nozzle unit 110 includes a channel 90 through which an ink or gas flows. The channel 90 penetrates the nozzle 22 along the first direction 134. The channel 90 extends along the first direction 134; however, it is not limited thereto, and the channel 90 may be curved. A cross-section shape of the channel 90 may be a circular shape or a shape other than the circular shape. In a state in which the nozzle 22 is mounted on the bottle main body 21, one end of the channel 90 communicates with the bottle main body 21 through an opening 93. The other end of the channel communicates with the outside of the nozzle 22 through an opening 94 on the distal end side of the nozzle. The opening 93 has a circular shape. Note that, the opening 93 may have a shape other than the circular shape. Additionally, as long as the opening 93 is formed in a proximal portion of the nozzle unit 110, it is not limited to a proximal surface 114. The opening 94 is formed in a tip surface 115 forming an end portion of the nozzle unit 110 in the first direction 134. The opening 94 has a circular shape. Note that, the opening 94 may have a shape other than the circular shape.

As illustrated in FIG. 12B, the nozzle unit 110 may include a first channel 191 and a second channel 192 as two channels 190. The first channel 191 and the second channel 192 may have either the same length or different lengths along the flowing direction of the ink. Additionally, the first channel 191 and the second channel 192 may have either the same cross-section shape and cross-section area or different cross-section shapes and cross-section areas. In addition, the number of the multiple channels 190 may be greater than two. In a case of including the multiple channels 190, the lengths and the shapes of the respective channels 190 may be either the same or different. In a case where the nozzle unit 110 includes the two channels 190, openings 193 and 195 formed in a proximal portion are formed in the same surface. However, the openings 193 and 195 may be formed in different surfaces. A first opening 194 and a second opening 196 are formed in the tip surface 115 forming an end portion of the nozzle unit 110 in the first direction 134. However, as long as the first opening 194 and the second opening 196 are formed in the tip portion of the nozzle unit 110, it is not limited to the tip surface 115. The first opening 194 and the second opening 196 have a circular shape. Note that, the first opening 194 and the second opening 196 may have a shape other than the circular shape.

The tip portion of the nozzle unit 110 is, for example, a portion formed of the tip surface 115 and the outer peripheral surface 112 of the nozzle unit 110. The nozzle unit 110 includes a concave portion 116 on the outer peripheral surface 112. The concave portion 116 is partitioned by the tip surface 115 and an inner peripheral surface 118 (one surface of a side surface) of a circular ring rib 117 protruding from an outer edge portion of the tip surface 115 in the first direction 134. That is, the tip surface 115 is concaved from the tip of the nozzle unit 110 (a tip of the circular ring rib 117). The inner peripheral surface 118 extends toward an outer edge of the tip surface 115 as advancing in the first direction 134 from the tip surface 115. That is, the inner peripheral surface 118 extends in the first direction 134 while being inclined in a direction in which the concave portion 116 is enlarged in diameter. Note that, the inner peripheral surface 118 may extend along the first direction 134 without inclination. Additionally, the nozzle unit 110 may not include the concave portion 116. That is, the tip portion of the nozzle unit 110 may not be concaved.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2023-127496 filed Aug. 4, 2023, and No. 2024-070382 filed Apr. 24, 2024, which are hereby incorporated by reference wherein in their entirety.

What is claimed is:

1. A liquid storage bottle, comprising:
a bottle main body that stores a liquid;
a nozzle from which the liquid stored in the bottle main body is ejected; and
a cap that seals the nozzle, wherein
in a first curving portion between a bottom surface and a side surface of the bottle main body in a cross-section of the bottle main body in a vertical direction, a curvature radius of an inner wall is greater than a curvature radius of an outer wall.

2. The liquid storage bottle according to claim 1, wherein
in a second curving portion between a top surface and the side surface of the bottle main body, a curvature radius of the inner wall is greater than a curvature radius of the outer wall.

3. The liquid storage bottle according to claim 1, wherein
a thickness of a wall of the bottom surface of the liquid storage bottle is thicker than a thickness of a wall of the side surface.

4. The liquid storage bottle according to claim 1, wherein
the bottle main body is formed of recycled plastic material or resin material that is a mixture of recycled plastic material.

5. The liquid storage bottle according to claim 4, wherein
the recycled plastic material is one type of or a mixture of a plurality of types out of PP, PE, PET, PVC, and PS.

6. The liquid storage bottle according to claim 1, wherein
the bottle main body contains 5 wt % or more of recycled plastic material.

7. The liquid storage bottle according to claim 1, wherein
the curvature radius of the inner wall of the first curving portion of the bottle main body is within a range of 1.0 mm or greater and 50 mm or smaller.

8. The liquid storage bottle according to claim 1, wherein
the curvature radius of the outer wall of the first curving portion of the bottle main body is within a range of 0.5 mm or greater and 50 mm or smaller.

9. The liquid storage bottle according to claim 2, wherein
the curvature radius of the inner wall of the second curving portion of the bottle main body is within a range of 1.0 mm or greater and 50 mm or smaller.

10. The liquid storage bottle according to claim 2, wherein
the curvature radius of the outer wall of the second curving portion of the bottle main body is within a range of 0.5 mm or greater and 50 mm or smaller.

11. The liquid storage bottle according to claim 1, wherein
a thickness of the bottom surface of the bottle main body is within a range of 0.5 mm or greater and 5.0 mm or smaller.

12. The liquid storage bottle according to claim 1, wherein
a thickness of the side surface of the bottle main body is within a range of 0.1 mm or greater and 5.0 mm or smaller.
